(19) United States
(12) Patent Application Publication
(10) Pub. No.: US 2023/0399857 A1
(43) Pub. Date: Dec. 14, 2023

(54) CONNECTABLE FLOOR TILE

(71) Applicant: M + A Matting, LLC, LaGrange, GA (US)

(72) Inventors: Tyler Fowler, LaGrange, GA (US); Lee Barnes, Kingston, GA (US)

(73) Assignee: M + A Matting, LLC, LaGrange, GA (US)

(21) Appl. No.: 18/208,011

(22) Filed: Jun. 9, 2023

Related U.S. Application Data
(60) Provisional application No. 63/351,026, filed on Jun. 10, 2022.

(51) Int. Cl. E04F 15/10; B32B 25/04; B32B 5/18; B32B 3/04; B32B 3/06; B32B 3/30; E04F 15/02; A47G 27/02

(52) U.S. Cl. CPC E04F 15/10; B32B 25/045; B32B 5/18; B32B 3/04; B32B 3/06; B32B 3/30; E04F 15/02005; A47G 27/0218; B32B 2419/04; B32B 2250/40; B32B 2307/546; B32B 2266/0235; B32B 2250/03; E04F 2201/0138; E04F 2201/091; E04F 2201/095; E04F 2201/098

(57) ABSTRACT

A connectable floor tile has a flexible, top layer, a flexible, middle layer or core, and a flexible, bottom layer. The combination of the top layer and bottom layer has sidewall portions having opposed marginal perimeter portions. The sidewall portions have an interior sidewall surface that abuts the middle core. The central portion defines a land that has a support surface. A plurality of spaced-apart cleats extend upwardly to respective distal surfaces and define channels therebetween.

### CROSS REFERENCE TO RELATED APPLICATIONS

This application claims the benefit of U.S. Provisional Patent Application No. 63/351,026 filed Jun. 10, 2022 and entitled “Connectable Floor Tile”, and is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### FIELD OF THE INVENTION

The present invention relates to floor mats and particularly anti-fatigue mats. More particularly, the invention relates to layered floor tiles that connect together as modules to cover an area as a mat.

Persons who have work or other needs for standing for long periods of time or for walking on hard floor surfaces such as concrete or tile often experience problems with their feet and with fatigue. To accommodate such work needs and assist with reducing fatigue from standing or walking on hard surfaces, anti-fatigue mats have been developed to provide a cushioned surface on which to stand or walk. There are various types of anti-fatigue mats, including foam, gel-filled, foam rubber, and hard rubber. Each type provides alternative benefits and features, but generally, each type of mat provides a cushioned or resilient body to soften the surface on which the person stands or walks. For small area workstations, for example, at a machinery control station or a photocopy machine, single small area mats are satisfactory. However, there are often needs to cover a larger areas, such as a small room or hallway.

Individual workstations may use a foam mat or a gel mat. Foam mats are readily manufactured but provide moderate support and moderate anti-fatigue while gel-filled offer superior support and anti-fatigue benefits. Foam rubber mats are suitable for industrial applications. Hard rubber mats may have interlocking pieces to assemble as a runner or to cover a large area.

While hard rubber mats with interlocking features may connect together to cover a large area, such may be unsatisfactory as lacking anti-fatigue properties. Foam mats having a resilient or cushioned base and an overlaid attached rubber surface are readily manufactured but have the drawback of not interlocking together satisfactorily. Die cutting of such foam mat to form the connecting members on side edges causes cupping in the side walls, and thereby reduces the effectiveness of the connection between adjacent tiles. Scuffing of footwear or wheeled traffic may also cause the rubber layer to delaminate or separate from the foam base.

Mats have also been designed that include a top layer of hard rubber and a bottom layer of softer foam material or foam substrate. This type of mat is shown in U.S. Pat. Nos. 8,919,054 and 11,174,648. A problem with these types of mats is that the foam bottom layer may absorb liquids, thereby degrading the foam material over time. Furthermore, any movement of the mat may cause the foam material to rip, tear or otherwise become damaged, which may also accelerate the absorption of the liquids into the foam layer.

Accordingly, there is a need in the art for combination rubber and foam-backed anti-fatigue tiles that resist damaging the foam material utilized as a cushioning material for a softer feel that may be used for connecting tiles together as an anti-fatigue mat to cover an area while also providing long lasting protection from the absorption of liquids. It is to such that the present invention is directed.

### BRIEF SUMMARY OF THE INVENTION

A connectable floor tile comprises a top rubber layer, a bottom rubber layer coupled to the top layer to form a marginal perimeter portion, the combination of the top layer, bottom layer, and marginal perimeter portion defining a rubber encapsulated cavity, and a foam core positioned within the rubber encapsulated cavity.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a top view of a connectable floor tile embodying principles of the invention in a preferred form.

FIG. 2 is a perspective view of a portion of the connectable floor tile of FIG. 1.

FIG. 3 is a cross-sectional view of a portion of the connectable floor tile of FIG. 1.

FIG. 4 is a cross-sectional view of a portion of a connectable floor tile in another preferred form.

### DETAILED DESCRIPTION OF CERTAIN EMBODIMENTS

With reference next to the drawings, there is a shown a connectable floor tile 10 in the illustrated embodiment. The floor tile 10 is similar to that described in detail in U.S. Pat. No. 8,919,054, which is specifically included herein by reference in its entirety. Here, the floor tile 10 includes a flexible, top layer 12, a flexible, middle layer or core 14, and a flexible, bottom layer 16.

The top layer 12 and bottom layer 16 are made of a generally hard yet flexible, molded rubber material. The top layer 12 has a central portion 20. The combination of the top layer 12 and bottom layer 16 has sidewall portions 21 having at least opposing first and second marginal perimeter portions 22, 24 and opposing third and fourth marginal perimeter portions 26, 28. The sidewall portions 21 have an interior sidewall surface 23 that abuts the middle core 14.

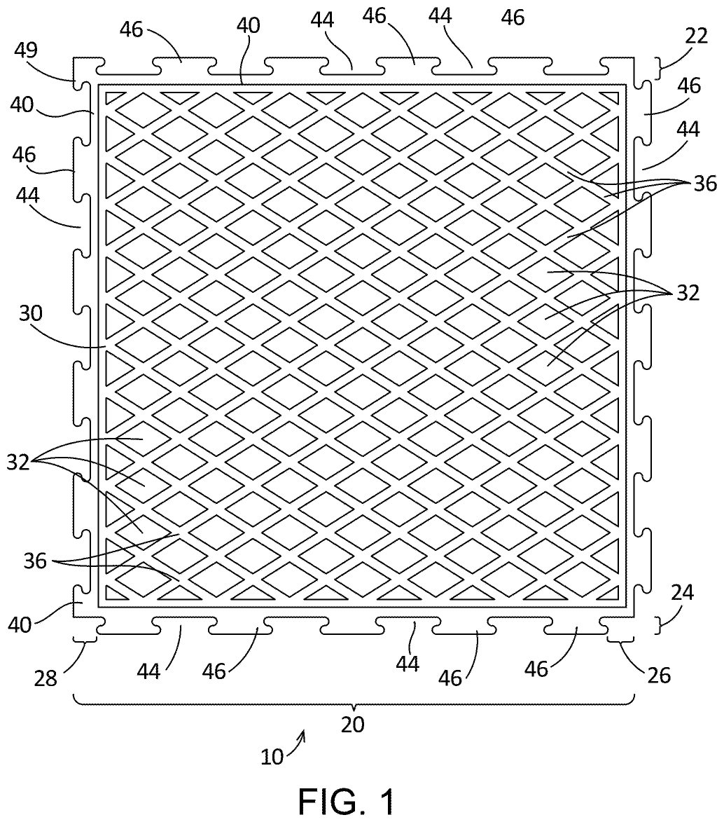

The central portion 20 defines a land 30. The land 30 has a support surface 34 for a purpose discussed below. In the illustrated embodiment, a plurality of spaced-apart cleats 32 extend upwardly to respective distal surfaces, that cooperatively define the support surface 34. As shown in FIG. 1, the spaced-apart cleats 32 define channels 36 therebetween. The illustrated cleats 32 are diamond-shaped, but may be configured as other shapes, such as squares, ovals, circles, lands, or other patterns, for defining the support surface for a purpose discussed below. In an alternate embodiment, the land 30 has a support surface not interrupted by channels 36. Alternatively, the support surface 34 may be textured, dimpled, corrugated, embossed, pebbled, defined with holes, ribs, have a grit-top, or raised cleat.

With continuing reference to drawings, the first and second marginal perimeter portions 22, 24 each define a respective second land 40 with a surface recessed relative to the distal support surfaces 34 of the cleats 32. In the illustrated embodiment, the first and second marginal perimeter portions 22 and 24 each define matingly engageable connectors to join adjacent ones of the tiles together. In the illustrated embodiment, an edge of the first marginal perimeter portion 22 defines at least one lug-receiving recess 44. The illustrated embodiment includes a plurality of the lug-receiving recesses 44 disposed in spaced relation. An edge of the opposing second marginal perimeter portion 24 defines at least one projecting lug 46 configured for mating reception by the lug-receiving recess 44. In the illustrated embodiment, the second marginal perimeter portion 24 defines a plurality of projecting lugs 46 in spaced-relation.

In the illustrated embodiment, the first and second marginal perimeter portions 22, 24 each define a plurality of alternating lug-receiving recesses 44 and projecting lugs 46. Further, the alternating lug-receiving recesses 44 and projecting lugs 46 in the first marginal perimeter portion 22 are off-set relative to the alternating lug-receiving recesses 44 and projecting lugs 46 in the second marginal perimeter portion 24, so that a lug-receiving recess in the first marginal perimeter portion opposes a projecting lug in the second marginal perimeter portion.

The foam core or middle layer 14 includes a foam substrate with a length and a width that exceeds a foam depth. The middle layer 14 attaches, such as during vulcanization, to the top layer 12 and bottom layer 16. Alternatively, the attaching may be accomplished through an adhesive, melting, or other similar process.

A plurality of the anti-fatigue tiles 10 gainfully join together to form an area-covering mat. The tiles 10 interconnect by the lug-receiving recess 44 of a first one of the laminated anti-fatigue tiles 10 matingly receiving a projecting lug 46 of a second one of the laminated anti-fatigue tiles. The tiles 10 thereby connect together to form a single connected mat for covering a large area, such as a room or to form a runner of the tiles for a hallway or aisle.

The lug-receiving recess 44 and the projecting lug 46 as illustrated have dovetail shapes for mating connection thereof. In the illustrated embodiment, the recess 44 and the lug 46 cooperatively define opposing ends.

An alternate embodiment (not illustrated) may have a tapered sloping perimeter edge rather than the mating connecting recesses and lugs. The sloping perimeter edge facilitates stepping onto the floor mat or for wheel-cart travel from a floor surface onto the floor mat. The tapered perimeter edge may be formed on one side (for adjacent tiles in a row of tiles on a side of an area-coverage mat), on two sides (such as for a corner tile piece), or on four sides (for a stand-alone floor tile.) Further, an alternate embodiment may define a geometric shape rather than rectangular.

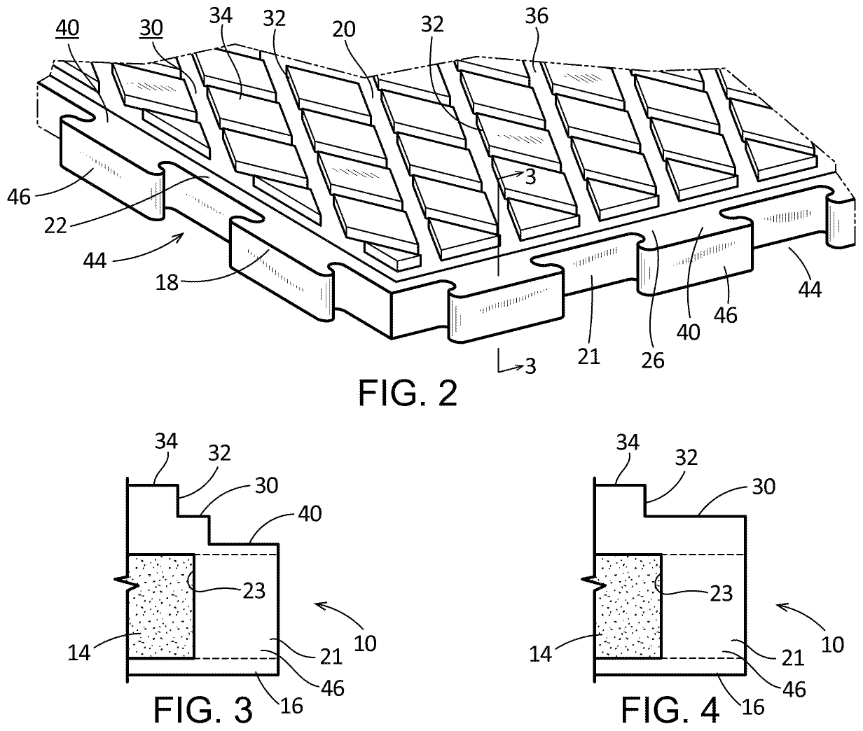

FIG. 3 illustrates in cross-sectional view features of the rubber/foam-backed/rubber laminated tile 10 taken along line 3-3 of FIG. 2. The foam core 14 provides a cushion interior structure. The rubber top layer 12 and bottom layer 16 are laminated by vulcanization to the foam core 14. The perimeter portions 22, 24 define the land 40 that is recessed relative to the support surfaces 34 of the cleats 32 extending from the land 30. The perimeter portions 22, 24 define the lug-receiving recesses 44 and lugs 46 for connecting adjacent tiles 10.

The tile 10 in the illustrated embodiment is manufactured from sheets of foam and rubber sized for the particular tile. The tile 10 may be assembled and formed upside down. A rubber top layer is placed in a mold. The mold has recesses that define the land 30 with the spaced-apart cleats 32 having the support surfaces 32 and defining the channels 36 between the cleats. Elongated side wall portions 21 are placed on the top sheet around a perimeter, to define the opposing first and second marginal perimeter portions 22 and 24 and the third and fourth marginal perimeter portions 26, 28. This defines a rubber encapsulated cavity that receives the foam insert 14. The foam insert 14 sits on a surface of the top layer 12 and abuts the respective inner wall surfaces 23. The rubber bottom layer 16 is overlaid on the foam core 14 and the surface of the elongated side walls portions 21. The mold defines the central portion 20 with the cleats 32 as well as the marginal perimeter portions 22, 24 (and in the illustrated embodiment 26, 28) with the second lands 40 recessed relative to the support surfaces 34. During the vulcanization heat and pressure process, the rubber top and bottom layers 12 and 16 conforms to the mold definitions for the central portion and the perimeter portions and laminates to the foam core 14. The top and bottom layers 12 and 16 are vulcanized together to form the marginal perimeter portions 22, 24, 26 and 28. The phantom lines in FIG. 3 indicates the top layer 12, the perimeter portions 21, and the bottom layer 16 that have now melded or melted together through the vulcanization process. The term rubber encapsulated cavity, as used herein, is intended to mean a cavity that it totally enclosed by the rubber layers so that liquids cannot intrude into the cavity at any point so as to prevent the foam insert 14 from being harmed by the intrusion or introduction of any chemicals that may pass into the cavity.

The blank of the vulcanized rubber/foam floor tile is removed from the mold and placed on a cutting apparatus for cutting marginal portions of the blank away by forming the lug-receiving recesses 44 and projecting lugs 46 on the marginal perimeter portions. The cutting tool is preferably a water-jet apparatus. The water jet operates as a cutting blade to cut through the rubber layers.

The method described above may gainfully be followed to manufacture a plurality of the tiles 10 simultaneously. The foam core 14 and the rubber top and bottom layers 12 and 16 are sized for the number of tiles 10 to be cut from a laminated blank. The discrete tiles 10 are separated from the laminated blank by simultaneously forming the lug-receiving recess 44 for a first of the plurality of anti-fatigue tiles and the projecting lug 46 for a second of the plurality of anti-fatigue tiles adjacent to the first anti-fatigue tile. This is accomplished by a cut line made by the water-jet, by which the adjacent anti-fatigue tiles are separated one from another.

The floor tile 10 of the present invention is disclosed in an illustrative embodiment as having a foam core 14 and a top and bottom layer 12 and 16 of a rubber sheet that upon vulcanization attaches to the foam while forming the structure of the central portion and the perimeter portions 21. The feature of the perimeter portions 22, 24 (and 26, 28) having the mating recesses and projections 44, 46 with the surface 40 recessed relative to the support surface 34, facilitates the tiles joined together to form an area-wide mat and to resist delamination of the top layer and the base substrate during use of the mat.

It is to be appreciated that layered tiles may gainfully be made of conventional mat materials and include the features of the present invention. This includes vinyl sponge tiles of a vinyl layer attached to a PVC foam (closed or open cell), in various thicknesses for selective cushioning, rubber top surface or layer that is heat bonded to PVC foam base (open cell or closed cell), PVC or other resilient sheet members attached, heat-bonded, fusion-bonded, adhered such as with an adhesive, glue, or joining material, laminated or otherwise connected to a base cushioning substrate such as foam, urethane sponge layers (such as providing highly resistant cushioning), the base substrate formed by curing a liquid foam material that adheres to the top layer, as well as other conventional materials that may be layered together to form a floor tile. Such tiles may gainfully apply the feature of the surface on perimeter portions recessed relative to the support surface 34 on which a user walks to resist delamination of the layers of the tile during use.

Through the encasement or sealing of the foam core 14 by the opposing top layer 12 and bottom layer 16, the foam core 14 is protected from liquids as fluid spills or water, that otherwise may seep into the foam material causing the foam material to degrade. The bottom layer 16 also protects the foam core 14 from ripping or tearing due to movement of the core 14 against the underlying floor. Therefore, it should be understood that providing a hard rubber bottom surface 16 provides a distinct benefit over tiles of the prior art.

As shown in FIG. 4, an alternative embodiment forms the laminated connectable mat 10 with the top layer 12, the elongated side wall portions 21, the foam insert 14, and the encapsulating bottom layer 16. Here, the land 30 extends laterally to the distal outward edge of the side wall portions, thereby eliminating the second land 40 of the previous embodiment.

Although a particular embodiment of the invention has been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

1. A connectable floor tile comprising:
a top rubber layer;
a bottom rubber layer coupled to the top layer to form a marginal perimeter portion;
the combination of the top layer, bottom layer, and marginal perimeter portion defining a rubber encapsulated cavity, and
a foam core positioned within the rubber encapsulated cavity.

2. The connectable floor tile of claim 1 wherein the top rubber layer is attached by vulcanization to the bottom rubber layer.

3. The connectable floor tile of claim 1 wherein the marginal perimeter portion includes a plurality of spaced-apart lugs and alternating dovetail lug-receiving recesses for joining a plurality of the floor tiles together as a mat.

4. The connectable floor tile of claim 1 wherein the top rubber layer is flexible and wherein the bottom rubber layer is flexible.

5. A connectable floor tile comprising:
a flexible top rubber layer;
a flexible bottom rubber layer coupled to the top layer;
the combination of the top layer and bottom layer forming an internal, encapsulated cavity and a marginal perimeter portion, and
a flexible foam core positioned within the encapsulated cavity.

6. The connectable floor tile of claim 5 wherein the top rubber layer is attached by vulcanization to the bottom rubber layer.

7. The connectable floor tile of claim 5 wherein the marginal perimeter portion includes a plurality of spaced-apart lugs and alternating dovetail lug-receiving recesses for joining a plurality of the floor tiles together as a mat.

8. The connectable floor tile of claim 5 wherein the top rubber layer is flexible and wherein the bottom rubber layer is flexible.
